(19) United States
(12) Patent Application Publication
(10) Pub. No.: US 2017/0294069 A1
(43) Pub. Date: Oct. 12, 2017

(54) TEMPERATURE-CONTROLLED VENDING MACHINE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: YONG-CHANG FAN, Wuhan (CN)

(21) Appl. No.: 15/141,844

(22) Filed: Apr. 29, 2016

(30) Foreign Application Priority Data
Apr. 11, 2016 (CN) 201610217965.5

(51) Int. Cl. G07F 9/10; F25D 31/00; F25D 17/06

(52) U.S. Cl. CPC G07F 9/105; F25D 17/06; F25D 31/006

(57) ABSTRACT

A temperature-controlled vending machine able to apply a required temperature uniformly within itself includes a cabinet and a temperature control system fixed at the bottom of the cabinet. The temperature control system includes a water tank, a compressor, a condenser, an evaporator defining an air outlet, and a cross-flow fan. The cross-flow fan includes a plurality of fan blades opposite to the air outlet and a housing defining an air guiding exit. The cross-flow fan is able to circulate cool air expelled from the evaporator from the bottom of the cabinet to the top of the cabinet.

### CROSS-REFERENCE TO RELATED APPLICATIONS

This application claims priority to Chinese Patent Application No. 201610217965.5, filed on Apr. 11, 2016, the contents of which are incorporated by reference herein.

### FIELD

The present disclosure relates to vending machines, and more particularly to a vending machine with a temperature control system.

### BACKGROUND

Vending machines include temperature control modules to control temperature of goods, to prevent the goods from going bad. Generally, the temperature control module includes an evaporator, a compressor, and a condenser. The temperature control module is located near the bottom of the vending machine. Accordingly, most of cool airflow expelled from the evaporator collects towards the bottom of the vending machine. Thus, the cool airflow may not quickly flow to the top of the vending machine.

### BRIEF DESCRIPTION OF THE DRAWINGS

Implementations of the present technology will now be described, by way of example only, with reference to the attached figures.

FIG. 1 is an isometric view of a vending machine in accordance with an embodiment.

FIG. 2 is an exploded view of the vending machine of FIG. 1.

FIG. 3 is an isometric view of a temperature control system of the vending machine of FIG. 1.

FIG. 4 is an exploded view of the temperature control system of FIG. 3.

FIG. 5 is similar to FIG. 4, but viewed from a different viewpoint.

FIG. 6 is an isometric view of a cabinet of the vending machine of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

A definition that applies throughout this disclosure will now be presented.

The term “comprising” means “including, but not necessarily limited to”; it specifically indicates open-ended inclusion or membership in a so-described combination, group, series, and the like.

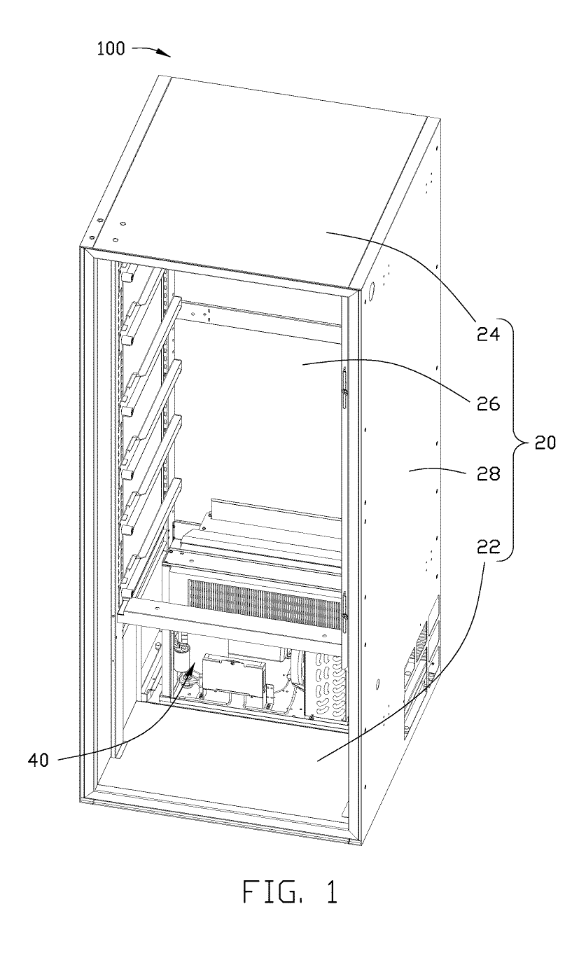

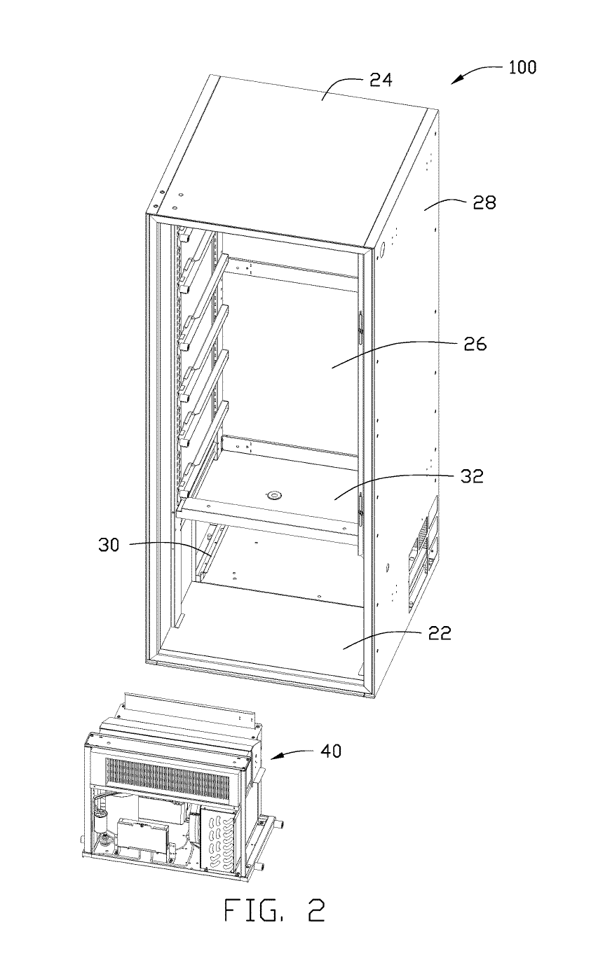

FIGS. 1 and 2 illustrate a vending machine 100. The vending machine 100 includes a cabinet 20 and a temperature control system 40. The temperature control system 40 is located adjacent the bottom of the cabinet 20. The temperature control system 40 controls a temperature of the vending machine 100 to prevent goods in the vending machine from going bad.

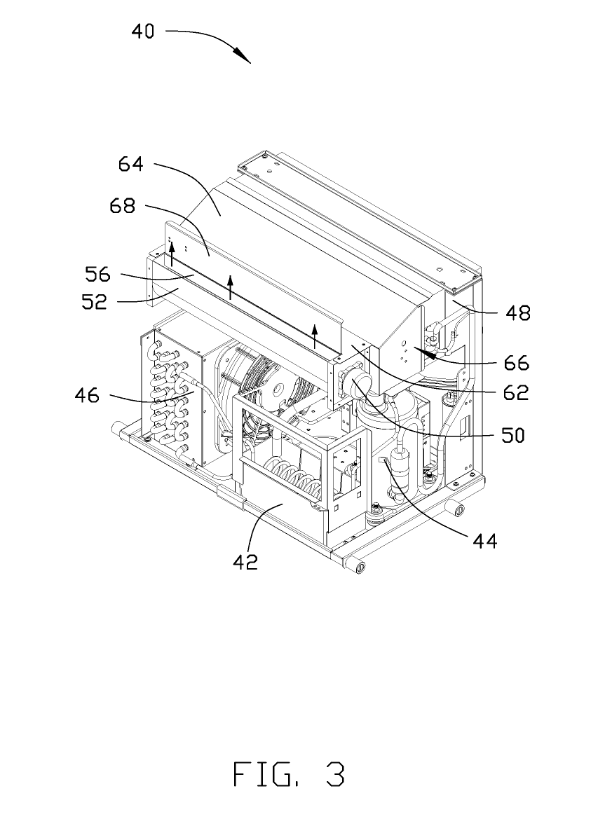

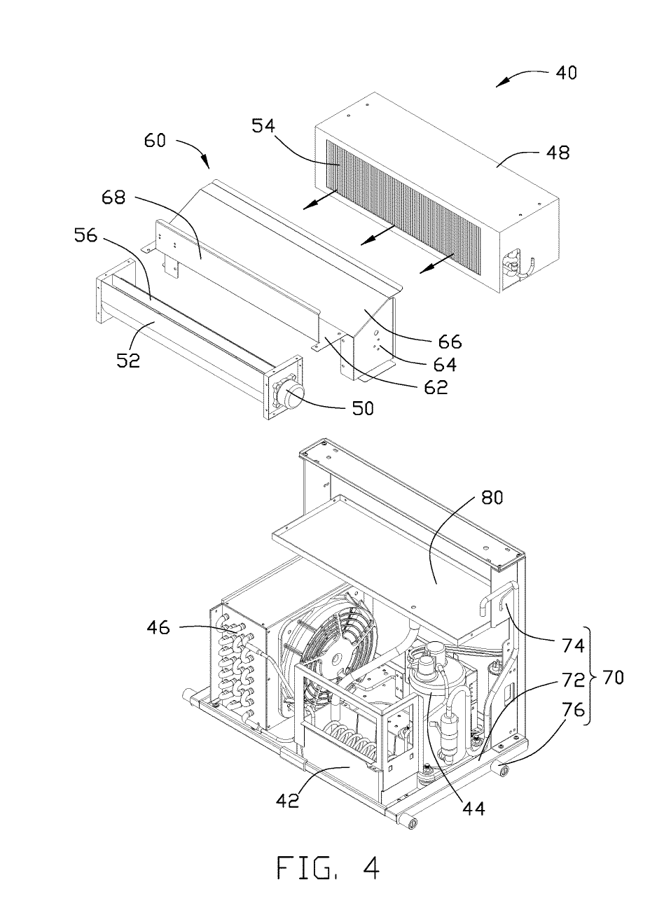

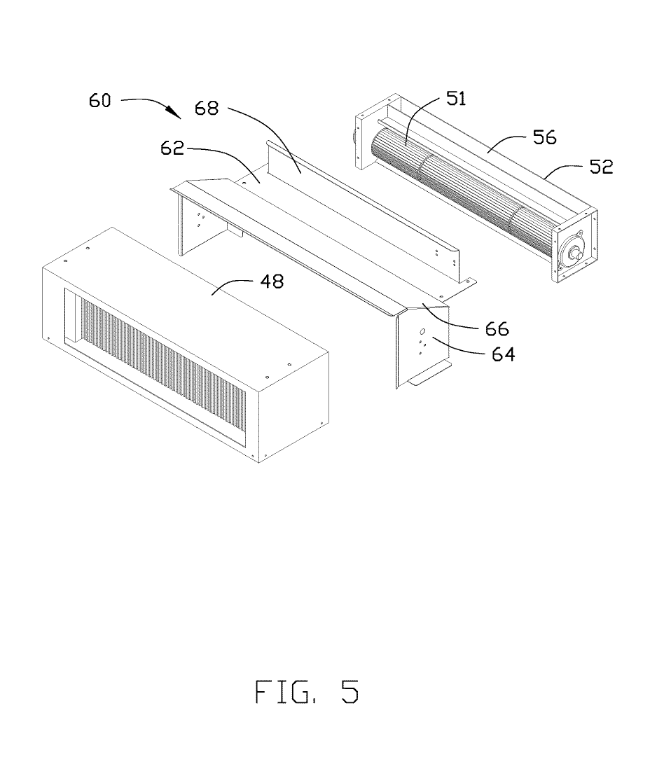

FIGS. 3-5 illustrate the temperature control system 40. The temperature control system 40 includes a water tank 42, a compressor 44, a condenser 46, an evaporator 48, and a cross-flow fan 50. The cross-flow fan 50 includes a number of fan blades 51 (FIG. 5) and a housing 52 receiving the fan blades 51. The evaporator 48 includes an air outlet 54. The air outlet 54 is on the opposite side of guiding cover 60 from the fan blade 51. The shell 52 defines an air guiding exit 56. The cross-flow fan 50 blows cool air expelled from the evaporator 48 to different parts of the vending machine 100, from the bottom of the cabinet 20 to the top of the cabinet 20, through the air guiding exit 56. The temperature control system 40 further includes an air guiding cover 60. The air guiding cover 60 is attached between the cross-flow fan 50 and the evaporator 48. The cool air blows from the evaporator 48 to the fan blades along the air guiding cover 60.

The air guiding cover 60 includes a first covering plate 62, a second covering plate 64, and two third covering plates 66. The first covering plate 62 is fixed to the shell 52. The second covering plate 64 obliquely extends between the first covering plate 62 and the evaporator 48. The two third covering plates 66 downwardly extend from opposite sides of the second covering plate 64. The edge of the second covering plate 64 and the two third covering plates 66 partly locate on the evaporator 48. The air guiding cover 60 further includes an air guiding plate 68. The air guiding plate 68 perpendicularly extends from an edge of the first covering plate 62 away from the evaporator 48 toward the top of the vending machine 100. The air guiding plate 68 is positioned between the air guiding exit 56 and the evaporator 48. Thus, the cool air is directed to different parts of the vending machine 100 along the air guiding plate 68.

The temperature control system 40 further includes a rack 70 and a separation plate 80. The rack 70 includes a fastening plate 72 and two supporting pillars 74. The two supporting pillars 74 are perpendicularly fixed to the fastening plate 72. The separation plate 80 is attached between the two supporting pillars 74 and positioned above the fastening plate 72. The evaporator 48 is fixed to the separation plate 80. The water tank 42, the compressor 44, and the condenser 46 are fixed to the fastening plate 72. The rollers 76 are fixed to opposite sides of the fastening plate 72. In the exemplary embodiment there are four rollers 76 enable the rack 70 to move relative to the cabinet 20.

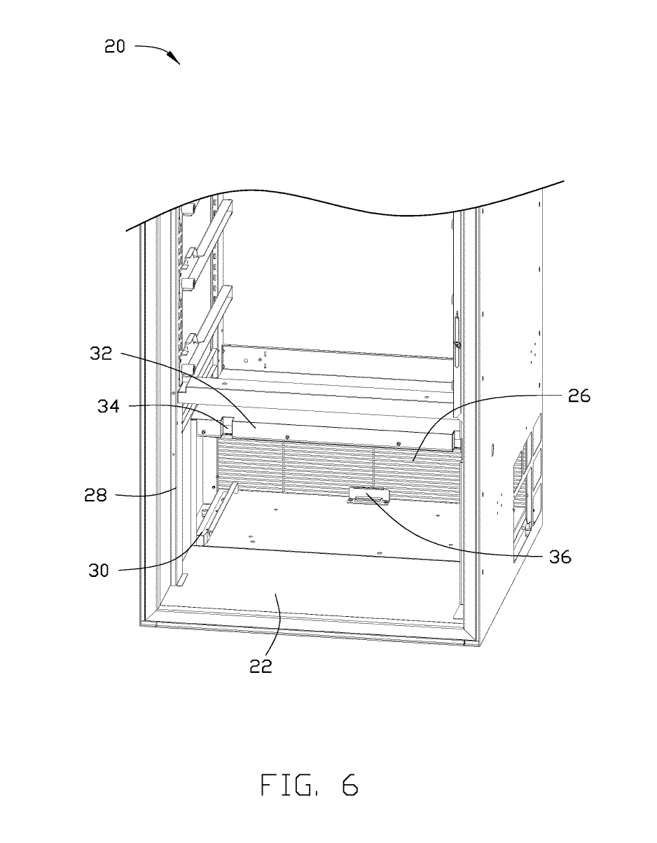

FIGS. 1 and 6 illustrate the cabinet 20, which includes a bottom plate 22, a top bottom 24, a rear plate 26, and two lateral plates 28. The two lateral plates 28 are fixed between the bottom plate 22 and the top plate 24. The lateral plates 28 are perpendicular to the bottom plate 22, the top plate 24, and the rear plate 26. Two sliding rails 30 are fixed to the bottom plate 22. The sliding rails 30 are adjacent to the two lateral plates 28. The Rollers 76 are movable along the sliding rail 30 to enable positioning of the rack 70 in the cabinet 20. The cabinet 20 further includes an installing plate 32. The installing plate 32 perpendicularly extends from adjacent the rear plate 26. A side of the installing plate 32 away from the rear plate 26 defines two gaps 34. The two supporting pillars 74 are partly received in the two gaps 34. The separation plate 80 is positioned on the installing plate 32. The cross-flow fan 50 is positioned on the installing plate 32 and faces the evaporator 48. A clip 36 is fixed to the rear plate 26. When the fixing plate 72 moves to the rear plate 26, the clip 36 locks the fixing plate 72.

The embodiments shown and described above are only examples. Even though numerous descriptions and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A vending machine comprising:
a cabinet;
a temperature control system located adjacent the bottom of the cabinet, the temperature control system comprising:
a water tank;
a compressor;
a condenser;
an evaporator including an air outlet; and
a cross-flow fan comprising a plurality of fan blades opposite to the air outlet and a housing defining an air guiding exit, the cross-flow fan blowing cool air expelled from the evaporator from the bottom of the cabinet towards the top of the cabinet.

2. The vending machine as claimed in claim 1, wherein the temperature control system further comprises an air guiding cover, the air guiding cover is attached between the cross-flow fan and the evaporator, the cool air blows from the evaporator to the fan blade along the air guiding cover.

3. The vending machine as claimed in claim 2, wherein the air guiding cover comprises a first covering plate, a second covering plate and two third covering plates, the first covering plate is fixed to the shell, the second covering plate obliquely extends between the first covering plate and the evaporator, the two third covering plates downwardly extend from two opposite sides of the second covering plate, the edge of the second covering plate and the two third covering plates partly locate on the evaporator.

4. The vending machine as claimed in claim 1, wherein temperature control system further comprises a rack and a separation plate, the rack comprises a fastening plate and two supporting pillars, the two supporting pillars are perpendicularly fixed to the fastening plate, the separation plate is attached between the two supporting pillars and positioned above the fastening plate, the evaporator is fixed to the separation plate, the water tank, the compressor and the condenser are fixed to the fastening plate.

5. The vending machine as claimed in claim 4, wherein rollers are fixed to opposite sides of the fastening plate.

6. The vending machine as claimed in claim 5, wherein the cabinet comprises a bottom plate, a top bottom, a rear plate and two lateral plates, the two lateral plates are fixed between the bottom plate and the top plate, the lateral plate are perpendicular to the bottom plate, the top plate and the rear plate, two sliding rails are fixed to the bottom plate, the sliding rails are adjacent to the two lateral plates, the roller is movable along the sliding rail.

7. The vending machine as claimed in claim 6, wherein the cabinet further comprises an installing plate, the installing plate perpendicularly extends from the rear plate, a side of the installing plate away from the rear plate defines two gaps, the two supporting pillars are partly received in the two gaps.

8. The vending machine as claimed in claim 7, wherein the separation plate is positioned on the installing plate.

9. The vending machine as claimed in claim 8, wherein the cross-flow fan is positioned on the installing plate and faces the evaporator.

10. The vending machine as claimed in claim 6, wherein a clip is fixed to the rear plate, the clip locks the fixing plate.

11. A vending machine comprising:
a cabinet;
an air cooling equipment fixed in the cabinet, the air cooling equipment comprising:
a water tank;
a compressor;
a condenser;
an evaporator defining an air outlet expelling cool air; and
a cross-flow fan comprising a plurality of fan blades facing the air outlet and a housing defining an air guiding exit, the cross-flow fan blowing the cool air to different parts of the vending machine through the air guiding exit.

12. The vending machine as claimed in claim 11, wherein the temperature control system further comprises an air guiding cover, the air guiding cover is attached between the cross-flow fan and the evaporator, the cool air blows from the evaporator to the fan blade along the air guiding cover.

13. The vending machine as claimed in claim 12, wherein the air guiding cover comprises a first covering plate, a second covering plate and two third covering plates, the first covering plate is fixed to the shell, the second covering plate obliquely extends between the first covering plate and the evaporator, the two third covering plates downward extends from two opposite sides of the second covering plate, the edge of the second covering plate and the two third covering plates partly locate on the evaporator.

14. The vending machine as claimed in claim 11, wherein temperature control system further comprises a rack and a separation plate, the rack comprises a fastening plate and two supporting pillars, the two supporting pillars are perpendicularly fixed to the fastening plate, the separation plate is attached between the two supporting pillars and positioned above the fastening plate, the evaporator is fixed to the separation plate, the water tank, the compressor and the condenser are fixed to the fastening plate.

15. The vending machine as claimed in claim 14, wherein rollers are fixed to opposite sides of the fastening plate.

16. The vending machine as claimed in claim 15, wherein the cabinet comprises a bottom plate, a top bottom, a rear plate and two lateral plates, the two lateral plates are fixed between the bottom plate and the top plate, the lateral plate are perpendicular to the bottom plate, the top plate and the rear plate, two sliding rails are fixed to the bottom plate, the sliding rails are adjacent to the two lateral plates, the roller is slidable along the sliding rail.

17. The vending machine as claimed in claim 16, wherein the cabinet further comprises an installing plate, the installing plate perpendicularly extends from the rear plate, a side of the installing plate away from the rear plate defines two gaps, the two supporting pillars are partly received in the two gaps.

18. The vending machine as claimed in claim 17, wherein the separation plate is positioned on the installing plate.

19. The vending machine as claimed in claim 18, wherein the cross-flow fan is positioned on the installing plate and faces the evaporator.

20. The vending machine as claimed in claim 16, wherein a clip is fixed to the rear plate, the clip locks the fixing plate.
